(19) United States
(12) Patent Application Publication
(10) Pub. No.: US 2016/0345387 A1
(43) Pub. Date: Nov. 24, 2016

(54) SYSTEM AND METHOD FOR PROCESSING SOLIDS AND LIQUIDS

(71) Applicant: Gerard RUSSOMAGNO, Lebanon, NJ (US)

(72) Inventor: Gerard RUSSOMAGNO, Lebanon, NJ (US)

(21) Appl. No.: 14/719,055

(22) Filed: May 21, 2015

(51) Int. Cl. H05B 6/06; H05B 6/42; H05B 6/36; H05B 6/04; H05B 6/10

(52) U.S. Cl. CPC H05B 6/06; H05B 6/04; H05B 6/10; H05B 6/365; H05B 6/42

(57) ABSTRACT

A magnetic induction heating element is used for outputting a magnetic field corresponding to an electrical current passing through the magnetic induction element. The magnetic induction element is placed close to or attached to a vessel in which a material containing a mixture of solids and liquids is to be processed to reduce the volume of liquid in the solid through evaporation. A current delivery circuit directs electrical current through the magnetic induction element. A sensor, such as a thermocouple, provides feedback to a controller about the progress of the material being processed in the vessel. A controller receives the signal from the thermocouple and inputs from an operator and outputs signals to the current delivery circuit to change the electric current being directed to the magnetic induction element, thus allowing the system to operation automatically.

### BACKGROUND OF THE INVENTION

1. Field of the Invention

The present invention relates to magnetic induction devices and their use in raising the temperature of a material during processing to reduce the volume of the material and render the processed material suitable for other purposes, including land disposal.

2. Description of Related Art

Materials comprising a mixture of solids and liquids often present challenges in terms of handling, transportation, processing, disposal, treatment, and, in some cases, regulatory requirements. Many industries faced those challenges on a daily basis, and addressing them often involves the provision of added time and expense.

In the case of the oil and gas industry, a system for stabilizing waste drilling mud for Earthen burial is disclosed in U.S. Pat. No. 4,913,585. The patent describes a process involving flocculating, aggregating, agglomerating, and dewatering waste drilling mud to separate out free water. The water may be reused or disposed of in a well, and the thickened and dewatered drilling mud solids may be further processed, such as with water absorbing binder, to produce a residue solid.

In International Patent Application No. WO1989008487, used drilling muds containing organic liquids and water-soluble salts are processed to render them environmentally acceptable for disposal. The muds are dried in drying tubes through which they are conveyed and held in suspension by screw conveyors, with the vapors evaporated from the mud flowing in a direction counter-current to the mud. Salts may be removed from the dried mud by dissolving with water, and the vapors may then be condensed and phase separated for further purification and possible re-use.

Several commercial systems are available to process waste drilling mud and reduce waste drilling mud volume. Clean Harbors, for example, employs an apparatus called a Drilling Fluid Management System having a sloped, generally-rectangular or tubular processing tank with integral auger to move material from one end of the vessel to the other. Liquids and solids separate within the vessel. Steam lines may be used to heat the apparatus and help volatilize the liquids from the solids. Another commercial company, Therma-Flite, offers a sloped bin and auger systems, but rather than using steam lines for heating, the system employs electricity to heat the auger within the bin to a pre-determined temperature. The heated auger heats up the waste drilling mud and fluid to help volatilize the fluid as the material is processed through the sloped bin.

In the mining industry, systems for processing oil sand tailings in an oil sands development site are disclosed in International Patent Application No. WO2014007905. The application describes a drying apparatus, including the use of filters and a vacuum, to recover the oil and water from solids. In one embodiment disclosed in the application, tailings are fed into a drying apparatus to form a concentrated tailings product and a fluid stream, each of which may be recovered. The application teaches nutsche filters, horizontal plate filters, filter presses, tube filters, bag filters, leaf filters, centrifugal filters, rotary drum filters, disk filters, and cartridge filters. A vacuum may be applied to assist in separating the fluids from the solids.

Evaporation of liquids by induction heating is well known. A vessel, in which a material to be processed is contained, is heated by inducing current in the vessel or vessel material (or both). As the vessel heats up, it transfers thermal energy to the material inside the vessel, which causes liquids in the material to evaporate. An alternating current is used to generate an alternative magnetic field in the vessel that, in turn, induces an eddy current in the vessel body (if it is made from a conducting material) or directly in the conducting evaporated material (if the vessel is a non-conducting material). The heating of the material this way (i.e., directly or by heat transfer from the heated vessel) can be controlled, such that the material is heated up to a desired temperature.

In U.S. Pat. No. 7,347,054, a system for heating a tank containing a liquefied gas (such as ammonia) by induction is disclosed. The system includes a horizontal pressure tank containing a liquefied phase of a gas in a heating zone. An electromagnetic induction coil creates an alternating magnetic field in the heating zone so as to heat the heating zone. Induction heating directly heats the material of the tank within its thickness. The patent application states that a performance is achieved five to ten times higher than the performance of a heating system using a heating element of equal power.

Induction heating is also recognized as a technique for treating drill cuttings (drilling mud, mining tailings). In U.S. Pat. No. 4,304,609, a system in which hydrocarbons are removed from solids, such as drill cuttings, is disclosed. The system involves an apparatus having a rotating cylindrical retort vessel with a counter rotating auger-type conveyor located along the bottom level of the vessel. The vessel is heated by an induction heating system surrounding the vessel and traveling along the length of the vessel. The system is disclosed as being useful in off-shore oil and gas well operation where drill cuttings can be processed such that they can be discharged overboard in an environmentally-acceptable manner.

In U.S. Patent Application No. 20060096119, a liquid solid separator utilizing inductive heating is disclosed. The system includes an electrically-conductive scroll conveyor contained within a non-magnetic and non-conductive housing under vacuum. A moveable alternating electric coil induction heating coil is disposed around the housing. A scroll (auger) pulls the solids through the housing, while operation of the coil heats the scroll, which in turn heats the solids being processed. One or more thermocouples and a computer maintain the internal temperature of the separator and coordinate where to position the coil to maintain the desired temperature of the solid material being processed. A controller controls current to the induction coil. Various sized electrical generators a provided for generating the necessary alternating current to the induction heating system. The patent application states that, in one embodiment, the coil operates between about 500 and 1000 kilowatts (kW), or between about 750 and 820 kW, and at about 750 kilo Hertz (kHz) and 1100 kHz. Different frequencies may be used. An induction transformer may be used to control the current provided to the coil.

In U.S. Pat. No. 5,914,065, an apparatus and method for heating a fluid by induction heating is disclosed. The patent generally teaches using permanent magnets positioned proximate a vessel to induce current in the vessel using a direct current source. The vessel or the magnets are moved relative to the other to induce eddy currents in the vessel, which heats up and transfers heat to a material inside the vessel.

In each of the above induction heating systems, the components of the heating system (e.g., induction heating elements, element supports, power source, voltage/current controller, etc.) are part of, and integral to, a larger material processing unit. In other words, they were designed for a particular, specific, and pre-determined application. What is needed, therefore, is a robust system for providing induction heating of materials at an on-site location on an as-needed, on-call basis, that can be tailored to a particular customer's need. An induction heating system that is portable, adaptable to a variety of different material processing vessel shapes and sizes, scalable, able to be integrated into existing operations on site, and that requires minimal operator training, is needed.

### BRIEF SUMMARY OF THE INVENTION

The present invention achieves the above needs by providing a customizable induction heating system that is portable, adaptable to a variety of different material processing vessel shapes and sizes, scalable to achieve the material processing throughput of the customer, able to be integrated into existing customer operations on-site, and that requires minimal operator training.

The present invention may be used for a variety of industries and industrial processes, including, among others, those found in the oil and gas drilling, environmental cleanup, agriculture, food processing, and mining industries.

In the off-shore drilling industry, operators currently dump drilling mud onto barges, transport the barge to an on-shore facility, where a second company takes custody of the drilling mud and dries it, often using the customer's drying material. The present invention could be employed right on the barge and reduce the transportation and drying time and expense.

The application of the present invention is suitable for the disposal of fluids accumulated by processes used in the oil and gas industry, primarily in the exploratory drilling segment of the industry. The drill cuttings (displaced Earth) and fluids by-products produced during drilling need to be dried or stabilized for transfer to disposal sites, which the present invention facilitates.

Magnetic induction heating involves passing an electrical current along a conductor to generate a magnetic field external to the conductor, which induces a current in a magnetic conducting material (e.g., a vessel wall, a material within the vessel) that is sufficiently close to the magnetic field (as discussed further below). Induction heating is highly efficient, as up to 90-percent or more of the power generated by the power source can be converted to thermal energy by way of the magnetic field. Even when factoring in the efficiency of an electrical generator (about 60-percent efficiency in terms of converting the energy capacity of the fuel into outputted power), induction heating is typically more efficient than traditional oven-type heating vessels, or direct heating of soil to evaporate liquids. Moreover, an object's temperature may be controlled more accurately using induction heating magnets compared to indirect heating sources, such as steam tubes, or direct heating sources, such as electrical resistance. Furthermore, magnetic induction heating works just as efficiently in extreme climates, such as January in North Dakota, as it does is the middle of July. Depending on ambient atmospheric humidity levels, an open vessel evaporation rate of about 30-percent by weight of liquid may be achieved over a short period of time.

The components of the inventive system may be part of a portable system that can be readily and easily moved from one on-site location to another upon request of site operators, and installed at the on-site location where it becomes a non-intrusive, efficiency-increasing component of the on-site operations with minimal retrofitting of existing facilities at the site. Present on-site personnel can be trained to use the system, which has a relatively simple user interface in the form of a control panel with input-output capabilities. The system may be quickly disassembled and moved to a new site with little effort.

For customers who do not wish to adapt the present invention components to their existing equipment, the present invention also provides for complete systems, including various shaped material processing vessels, such as three-sided open bins, half-pipe open troughs, and inclined, closed, auger vessels, in which induction heating elements are used. For customers needing liquid volume reduction, the induction heating vessels may be equipped with a storage tank, pump, and sprayer heads to flash evaporate the liquids using induction heating.

The present invention provides for decreased shipping costs by reducing the volume (and thus weight) of the materials to be processed, which in some industries, such as oil and gas drilling, may be significant (upwards of 600-900 tons of material per drill hole) and one of the principal factors in slowing overall operational efficiency. Moreover, by reducing the volume (and weight) of the processed material, tipping fees for land disposal of the dried solids can be significantly reduced. Also, by evaporating most, if not all, of the liquids from the solids, less liquids need to be sent to water treatment facilities, thus reducing the burden on those facilities.

### BRIEF DESCRIPTION OF THE DRAWINGS

Exemplary embodiments will be set forth with reference to the drawings, in which:

FIG. 1 is a block diagram of a system according to one aspect of the present invention;

FIG. 2 is another block diagram of a system according to another aspect of the present invention, showing some of the relationships between components of the system:

FIG. 3 is a perspective view schematic diagram of a material processing vessel and general process flow according to one aspect of the present invention;

FIG. 4 is a perspective view schematic diagram of another material processing vessel and general process flow according to another aspect of the present invention;

FIG. 5 is a perspective view schematic diagram of yet another material processing vessel and general process flow according to another aspect of the present invention;

FIG. 6 is a process flow diagram according to one aspect of the present invention;

FIG. 7 is another block diagram of a system according to one aspect the present invention, showing various components of the system;

FIG. 8 is a cross-sectional elevation view diagram of the induction heating element, vessel, and material to be processed, according to one aspect of the present invention;

FIG. 9 is a perspective view schematic and block diagram of one embodiment of the invention in which a liquid is flash evaporated according to the present invention;

FIG. 10 is a side elevation view diagram of a material processing vessel and induction heating element according to one embodiment of the present invention; and

FIG. 11 is side elevation schematic view diagram of another material processing vessel and induction heating element according to one embodiment of the present invention.

### DETAILED DESCRIPTION OF THE INVENTION

Exemplary embodiments of the present invention will be set forth in detail with reference to the accompanying drawings identified above, in which like reference numerals refer to like elements throughout.

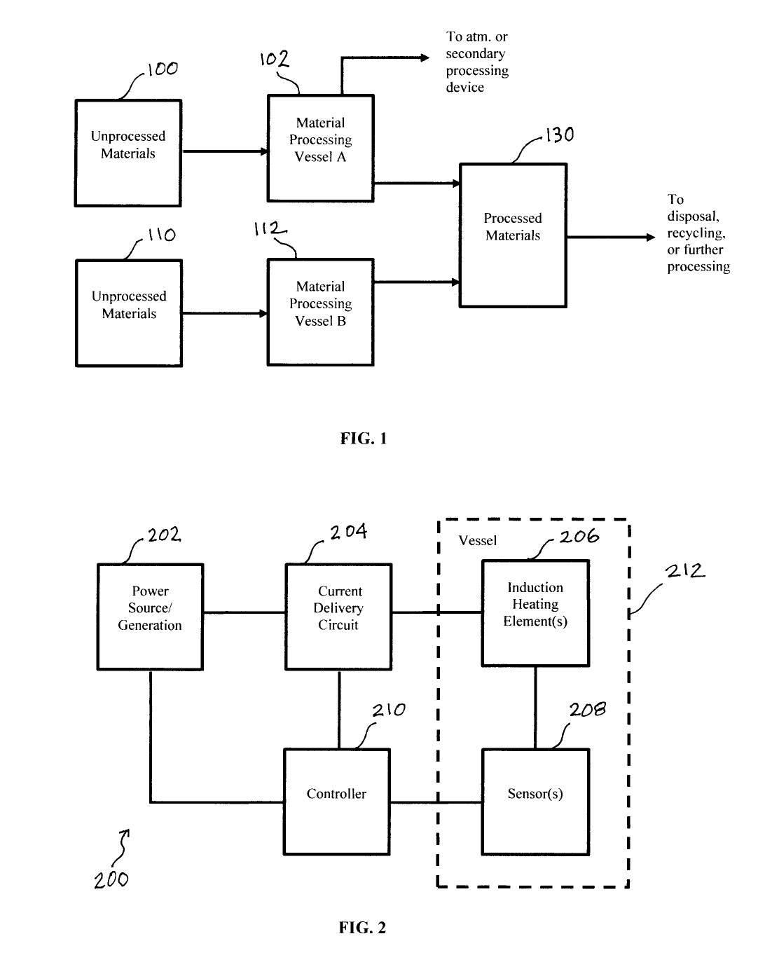

Turning first to FIG. 1, shown therein is a block diagram of a system according to one aspect of the present invention. In particular, the depicted system involves a first material 100 that has not been processed, or that has not been processed to a desired degree and requires additional processing. The depicted system may involve a second material 110 that also has not been processed, or that has not been processed to a desired degree and requires additional processing.

The material 100 and material 110 may be the same material, or they may be different materials. The materials 100, 110 may be, for example, drilling mud from an oil or gas drilling operation, mining tailings from a surface or underground mining operation containing aqueous or non-aqueous substances, hazardous materials generated by an industrial process containing hazardous liquids, non-hazardous contaminated materials generated by an owner/operator of a facility containing non-hazardous liquids, etc. Generally, the materials 100, 110 are solids mixed with a liquid, such as, for example, Earthen cuttings from a drill hole, which is mixed with drilling water or hydraulic fracturing fluids that the customer wants separated from the solids.

As further depicted in FIG. 1, a material processing vessel 102 may be used to process the first material 100, and a material processing vessel 112 may be used to process the second material 110. Additional material processing vessels (not shown) may also be used to scale the process to a level that provides sufficient throughput to meet the customer's need. The vessels 102, 112, may each be, for example, an open three-sided bin as commonly used on-site at land drilling operations for storing and processing drilling mud. The vessels 102, 112 may instead each be, for example, a generally elongated half-pipe trough, sized to accommodate a front-end bucket loader, for storing and processing drilling mud. The vessels 102, 112 may instead each be, for example, an elongated, inclined, closed-ended, rectangular-shaped auger conveyor for continuous feeding and processing of drilling mud. Other types and shapes of vessels are also contemplated as being within the scope of the present invention. The vessels 102, 122 may be the same or different types of vessels, and have the same or different configurations.

Once processed in the vessels 102, 112, the materials 100, 110 (and any processed materials from other vessels), may be combined in a single processed materials vessel or lay-down area 130 located on-site, or they may be kept separate, and then together or separately input into a stream for ultimate disposal, recycling, further processing, etc. In practice, the processed materials 130 are loaded onto trucks for transportation to, for example, a different site, such as a landfill or treatment facility. Some of the processed materials in the process materials vessel/lay-down 130 may be re-used at the site.

Turning next to FIG. 2, shown therein is another block diagram of a system 200 according to another aspect of the present invention, showing some of the relationships between components of the system 200. In particular, the depicted system 200 includes a power source or power generation subsystem 202, a current delivery circuit subsystem 204, a magnetic induction heating element subsystem 206, a sensor subsystem 208, and a controller subsystem 210, each of which is described below.

The power source or power generation subsystem 202 may be an existing 110/120/220/400-V service located on-site, which provides electrical service from a grid distributor, appropriately transformed from the grid service voltage/current to a suitable voltage and alternating current. The power source or power generation subsystem 202 may instead be a source of power delivered from available on-site electrical generator(s) provided by the site owner. Where such electrical service is not available, the system 200 may include a stand-along electrical generator, which one skilled in the art will understand should and could be sized to provide the necessary power (and alternating current) to the system 200 components. For example, a suitable electrical generator may produce about 1-2 kVA or up to 2000 kVA, depending on site-specific needs of the customer. The electrical power generation subsystem 202 may be an electrical generator mounted on skids, vehicle mounted, or otherwise made portable for easy transport from site to site.

The current delivery circuit subsystem 204 provides the necessary alternative current to the magnetic induction heating element subsystem 206. The circuit subsystem 204 may be an integral component of the electrical power generation subsystem 202, or may be a separate component that ties into the control unit of the electrical power generation subsystem 202. The circuit subsystem 204, which may include a transformer, may provide the function of conditioning the output current to maintain it between upper and lower designated limits to provide efficient operation of the magnetic induction heating element subsystem 206.

The magnetic induction heating element subsystem 206, consists of one or more magnetic induction heating elements, such as those manufactured by the Ambrell Company, modified as necessary to account for site-specific processing vessels and operating conditions. The magnetic induction heating elements are to be positioned proximate to the vessel 212, as described in detail later, such that the magnetic field generated by the magnetic induction heating elements permeates all or some of the vessel 212, or all or some of the material on or inside the vessel 212, or both, thereby causing the temperature of the material to increase up to, and be maintained at or within, a desired temperature range during a pre-determined time period and for a pre-determined amount of time, as further described later.

The sensor subsystem 208 may be a Joule-type sensor, such as a thermocouple, or an infrared sensor, such as a pyrometer. A thermocouple directly or indirectly assesses the apparent temperature of an object (such as the aforementioned vessels or materials being processed inside the vessels) by placing the thermocouple in direct contact with the object. The pyrometer indirectly assesses the apparent temperature of the object (such as the aforementioned material being processed) by placing the sensor near the object and detecting radiation emitted by the object. Other sensor types or a combination of sensor types for measuring different system parameters or site-specific conditions, may be used as part of the sensor subsystem 208.

The controller subsystem 210 provides various functions, including receiving electrical signals from the sensors of the sensor subsystem 208, where the electrical signal corresponds to, for example, a particular temperature or other parameter or condition being monitored. Another function of the controller subsystem 210 is to interpret the temperature signals and send signals to the current delivery subsystem 204 to increase or decrease the current being passed through the induction heating elements of the magnetic induction heating element subsystem 206. Another function is to maintain the elapsed time indicative of the amount of time the system 200 has been operating, or how long a particular temperature has been achieved, or how long a particular current has been passed through one or more induction heating elements, among other functions. Another function of the controller subsystem 210 is to generate information on a display (not shown) for the operator to observe, and to receive inputs from the operator via a control panel, which may consist of a touch screen or physical push-type buttons, rotatory knobs, or the like. The controller subsystem 210 may include a processor, memory, and communications capabilities to record and transmit signal data or system operating status information that may be archived and evaluated for trends, efficiencies, anomalies, or other purposes.

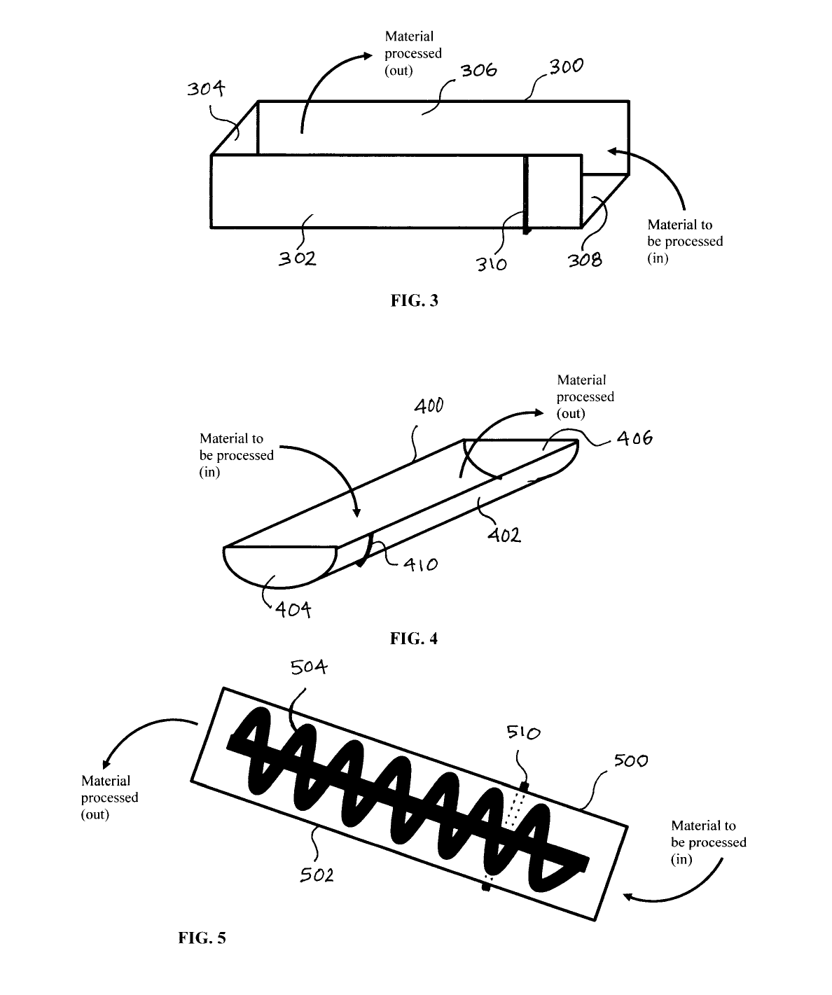

Turning next to FIG. 3, shown therein is a perspective view schematic diagram of a material processing vessel 300 and general process flow according to one aspect of the present invention. As depicted, the vessel 300 is a three-sided, bin-type vessel, usually placed directly on the ground. A typical bin is about 10 feet wide at the open end where materials to be processed are placed inside the bin. The length of the bin may be 40 feet, or some other dimension. The walls 302, 304, and 306 of the vessel 300 may be any suitable height above the floor, preferably between 10 and 60 inches.

The floor 308 of the vessel 300 is of suitable material, thickness, and construction to support the weight of the maximum design amount of materials to be processed inside the bin, plus the weight of a typical front-end loader that will roll into and out of the vessel 300 during loading and unloading operations.

The walls 302, 304, 306 and the floor 308 of the vessel 300 are typically constructed using more than one rib 310 (only one depicted) to provide added strength to the vessel 300. The ribs 310 may be spaced apart along the longitudinal length of the vessel 300 at regular intervals, and may coincide with joints between adjacent sections of the vessel (when made in sections that are joined together).

The vessel 300 is usually constructed of galvanized steel, structural polymeric composite material, a carbon fiber-reinforced polymeric composite material, a carbon fiber-reinforced fiberglass, reinforced cement, aluminum, or other structurally-sound material, preferably having a relatively low magnetic permeability so it does not heat up above acceptable levels during operation of the magnetic induction elements.

Turning next to FIG. 4, shown therein is a perspective view schematic diagram of another material processing vessel 400 and general process flow according to another aspect of the present invention. As depicted, the vessel 400 is a half-pipe trough (generally circular or semi-circular in cross-section), and usually placed directly on the ground (stabilized with footers (not shown)). A typical trough is about 4-6 feet wide at the open top where materials to be processed are placed inside the trough. The length of the trough may be 40 feet, or some other dimension. The walls 402, 404, and 406 of the vessel 400 may be any suitable dimension, including about 30 inches (measured radius; i.e., about 5 feet across at the top).

The wall 402 of the vessel 400, which performs the function of wall and floor, is of suitable material, thickness, and construction to support the weight of the maximum design amount of materials to be processed inside the trough, plus any contact force from a typical front-end loader that will dump into and scoop out of the vessel 400 materials during loading and unloading operations.

The walls 402, 404, and 406 of the vessel 400 are typically constructed using more than one rib 410 (only one depicted) to provide added strength to the vessel 400. The ribs 410 may be spaced apart along the longitudinal length of the vessel 400 at regular intervals, and may coincide with joints between adjacent sections of the vessel (when made in sections that are joined together).

The vessel 400 is usually constructed of galvanized steel, structural polymeric composite, carbon fiber-reinforced polymeric composite, carbon fiber-reinforced fiberglass, reinforced cement, aluminum, or other structurally-sound material, preferably having a relatively low magnetic permeability so it does not heat up during operation of the magnetic induction elements.

Turning next to FIG. 5, shown therein is a perspective view schematic diagram of yet another material processing vessel 500 and general process flow according to another aspect of the present invention. As depicted, the vessel 500 is a generally rectangular, square, or round (or oval) vessel and is inclined at a pre-determined or adjustable angle (the angle being adjustable on-site to accommodate a particular application). A typical vessel 500 is about 4 to 5 feet wide (or it has that diameter, in the case of a circular vessel shape) along its entire length (although changes to the shape, measured in cross-section along its length, may be provided from one end to the other). The length of the inclined vessel may be about 10-20 feet, or longer, and may consist of two or more smaller length vessels operated in series to provide the equivalent of a single longer vessel.

The walls 502 of the inclined vessel 500 is of suitable material, thickness, and construction to support the weight of the maximum design amount of materials to be processed inside the inclined vessel 500.

The walls 502 of the inclined vessel 500 are typically constructed using more than one rib 510 (only one depicted) wrapped around the inclined vessel 500 (partially or completely) in a direction that is generally perpendicular to the longitudinal axis of the inclined vessel 500 to provide added strength to the inclined vessel 500. The ribs 510 may be spaced apart along the longitudinal length of the inclined vessel 500 at regular intervals, and may coincide with joints between adjacent sections of the vessel (when made in sections that are joined together). The ribs 510 may instead run along the walls 502 in a longitudinal direction parallel to the longitudinal axis of the inclined vessel 500.

The inclined vessel 500 is usually constructed of galvanized steel, structural polymeric composite, carbon fiber-reinforced polymeric composite, carbon fiber-reinforced fiberglass, reinforced cement, aluminum, or other structurally-sound material, preferably having a relatively low magnetic permeability so it does not heat up during operation of the magnetic induction elements.

Inside the inclined vessel 500 is an auger 504 fixed at both ends so that the outside edge of the auger's strake, paddles, blades, or threads (depending on its construction) are in close proximity to the lower inside wall (floor) of the inclined vessel 500 in order to push the material being process from the lower inlet end of the inclined vessel 500 to the upper outlet end of the inclined vessel 500 in a continuous manner. Preferably, the auger 504 (or at least the outer peripheral edge of the auger 504 closest to the walls 502 of the inclined vessel 500) is made of a material that is of relatively low magnetic permeability so it does not heat up during operation of the magnetic induction elements. A ladder conveyor attached to a continuous belt on the floor of the inclined vessel 500 may also be used to help push some of the material from one end of the inclined vessel 500 to the other.

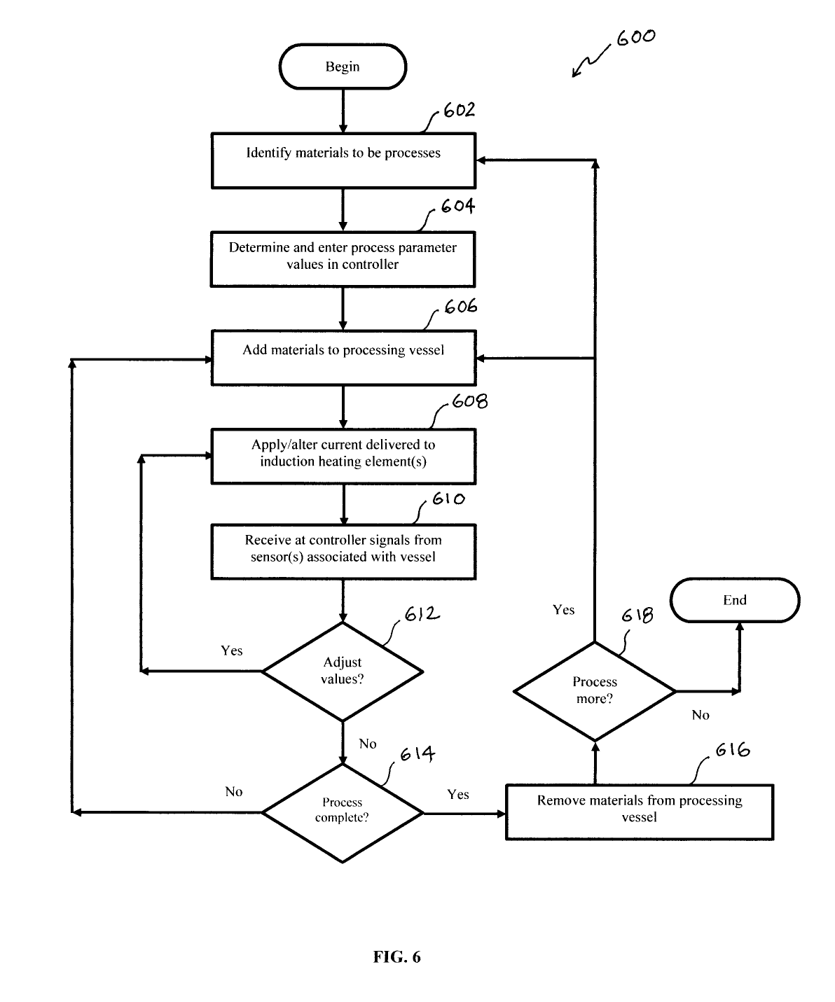

Turning next to FIG. 6, shown therein is a process flow diagram 600 according to one aspect of the present invention. In step 602, the materials to be processed are identified by the customer (typically one who owns or operates the facility where the system of the present invention will be used). For example, in a land-based hydraulic fracturing drilling operation where well drilling operations are commencing, the customer may identify drilling mud and cuttings as the materials to be processed.

In step 604, with reference to FIG. 2 for illustrative purposes only (and not to limit the process descried in FIG. 6 to the system of FIG. 2), the parameters that will govern operation of the system 200 will be identified, and then values for those parameters will be input into the controller subsystem 210. For example, if it is known that the primary component of the liquid in the drilling mud is water, a value input into the controller subsystem 210 for the desired apparent temperature of the material being processed should be higher than the temperature at which the water will evaporate. Moreover, if it is known that the vessel 212 will be an open bin-type vessel like the one shown in FIG. 3, a value input into the controller subsystem 210 for the temperature of the material being processed should be no greater than the melting point (or softening point) of the compound used in the tires of the front-end loader (e.g., a CAT 29 loader) used to load and unload material into the vessel 212 to avoid causing damage to the loader's tires. Ambient air temperature and humidity values may also be input into the controller subsystem 210 (or these may be automatically measured by a wet/dry-bulb thermometer and/or hygrometer). The amount of time to heat up the material and the amount of time the material is heated at a desired temperature may also be input into the controller subsystem 210. Wind direction and wind speed values may be input or automatically measured, so that operations are adjusted depending on a particular wind speed/direction or range of wind speeds/directions. Various alarm values may also be input, such as a low fuel level indication with regard to the power generation subsystem 202, or drop in the current being passed to the induction heating element subsystem 206, among others.

In step 606, the material to be processed, in this case drilling mud, is added to the vessel 212 in continuous batches (e.g., one batch, followed by a second batch, etc., or continuously processed in the case of an auger vessel). As mentioned previously, multiple vessels 212 may be run in parallel, such that multiple continuous batches are being processed simultaneously. A dump truck may deliver the unprocessed materials to the vessel 212 and dump it at the leading edge near the opening of the bin, and the front-end loader then pushes the material into the bin toward the back end farthest from the opening where the induction heating elements are positioned under the floor of the vessel 212.

In step 608, a pre-programmed (or default) current is delivered by the current delivery circuit subsystem 204 to the induction heating element subsystem 206 to induce heating in the vessel and/or the material inside the vessel (or both) which causes the liquids, primarily water in this example, to begin to evaporate. The materials may be scooped up and re-spread to facilitate an even distribution of heat throughout the materials during this heating process.

In step 610, while a current is delivered by the current delivery circuit subsystem 204 to the induction heating element subsystem 206 to induce heating of the material, the various sensors of the sensor subsystem 208 monitor some of the system parameters describe above, such as the temperature of the vessel 212 and/or the materials inside the vessel 212. Those sensors output a signal to the controller subsystem 210.

In step 612, the controller subsystem 210 compares the received signals from various inputs to pre-determined, default, or operator-inputted values and makes a determination as to whether the system 200 is operating properly and with acceptable ranges. If it needs to, the controller subsystem 210 sends a signal to the current deliver circuit subsystem 204 causing it to adjust the current being passed to the induction heating elements of the induction heating elements subsystem 206, such as by changing the amount of current and/or the frequency at which the current direction is alternated in the induction heating elements. If no adjustments are needed, the controller subsystem 210 does not send any signals but continues to receive signals from various sensors or inputs from operators.

In step 614, the controller subsystem 210 determines if the processing of the materials in the vessel 212 is complete by monitoring the signals from the sensors or the amount of time elapsed, or receiving a stop command input by an operator. If the process is not complete, the material being processed in the vessel 212 will continue to be processed for additional time, and additional unprocessed material may be added batch-wise to the vessel 212 to begin processing.

In step 616, material that has been processed is removed from the vessel 212, and is further processed or treated on-site, or shipped off-site for further processing, treatment, re-use, recycling, or disposal.

In step 618, the customer (typically one who owns or operates the facility where the system of the present invention will be used) decides whether additional materials are to be processed, and, if so, the system is used again in a continuous, batch, or some other manner.

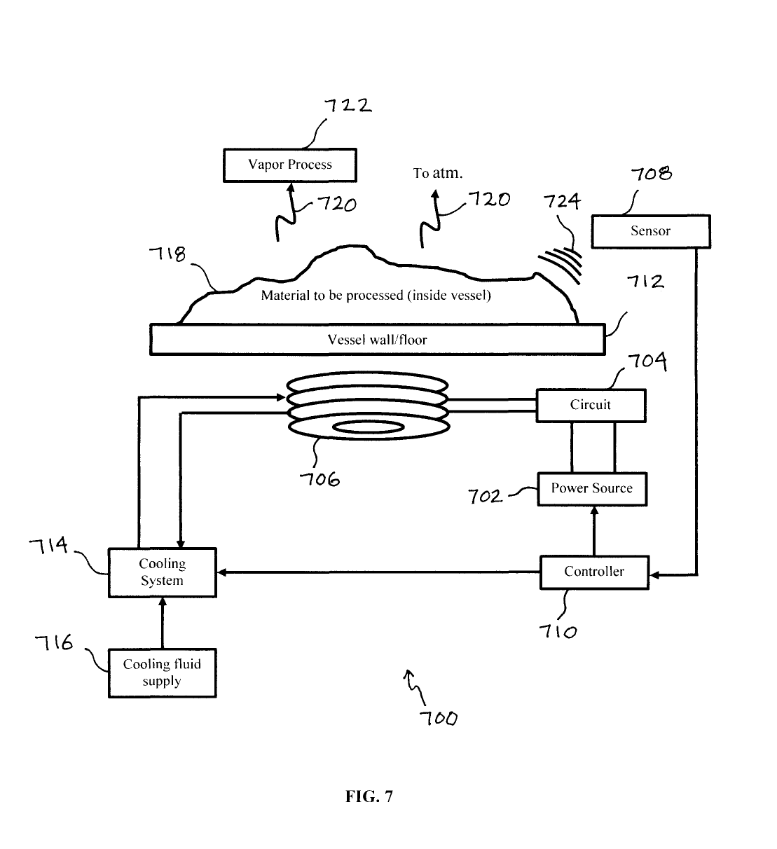

Turning next to FIG. 7, shown therein is another block diagram of a system 700 according to one aspect the present invention, showing various components of the system. In particular, depicted are a power source 702, a transformer/current conditioning circuit 704, a magnetic induction heating element 706, a sensor 708, a controller 710, a wall of a processing vessel 712, a cooling system 714, a cooling fluid supply 716, a batch of material being processed 718, and an amount of vapors or gases 720 transferring from the material 718 to the bulk atmosphere or to a vapor collection and processing device 722.

The power source 702 may be, as described above, an electrical generator mounted on skids, vehicle mounted, or otherwise made portable for easy transport from site to site.

The transformer/current conditioning circuit 704 may be a circuit that provides the designated or designed amount of current to the magnetic induction heating element 706, and the frequency at which the current direction within the induction heating element 706 is alternated. The transformer converts the standard output from a pole-supplied electrical source or electrically generator-supplied source to a frequency that is appropriate or optimal for the particular application.

The magnetic induction heating element 706 is placed proximate to (as described later) or directly on the wall of the processing vessel 712. For example, the heating element 706 may be placed on the ground below the floor 308 of an open bin-type vessel 300, or it may be attached to the outer wall 402 of a half-pipe, open trough-type vessel 400, or it may be attached to the side of the inclined vessel 500. The induction heating element 706 may be used in processes where the temperatures of the material being process is above about 212° F., and where the temperature is maintained for a few hours, days, weeks, or months, as needed.

A thermocouple or pyrometer sensor 708 is placed in direct contact with the vessel 712 or in close proximity to the material being processed to sense the thermal temperature of the vessel 712 and/or the material within the vessel 712, or to sense the radiating heat 724 emitted by the material during processing. Both types of sensors may be used, and multiple sensors 708 may be associated with a single vessel 712.

The controller 710 may provide, as described above, a combination of various functions, including receiving electrical signals from the sensor 708 where the electrical signal corresponds to a particular temperature. The controller 710 interprets the temperature signals and send signals to the transformer/current conditioning circuit 704 to increase or decrease the current being passed through the induction heating element 706. The controller 710 may also maintain an elapsed time indicative of the amount of time the system 700 has been operating, or how long a particular temperature has been achieved, or how long a particular current has been passed through the induction heating element 706, among other functions. The controller 710 may generate information on a display (not shown) for the operator to observe, and to receive inputs from the operator via a control panel, which, as described previously, may consist of a touch screen or physical push-type buttons, rotatory knobs, or the like.

The cooling system 714 may be used to cool the induction heating element 706 during operation when the temperature of the element itself approaches, equals, or exceeds a pre-determined temperature value that is stored in the controller 710. The cooling system 714 may be a counter-current heat transfer system using water or some other liquid as the working fluid, which is stored in a cooling fluid supply tank 716. The thermal energy of the working fluid is reduced by use of a radiator, cooling tower, or the like (not shown), which transfers the thermal energy from the fluid to the atmosphere.

In many instances, as a batch of material being processed 718 is reduced in volume due to evaporation of liquid, the vapors and gases 720 emitted from the material is simply transferred to the atmosphere as describe above. In other cases, it may be desired to install a vapor collection and processing device 722, which may be any one of several known devices for processing a stream of vapor or gases. For example, it may be desired to collect volatile organic compounds (VOCs) in the vapors/gases evaporating rom the material 718, and separate them from other vapors/gases before discharging the other vapors/gases to the atmosphere.

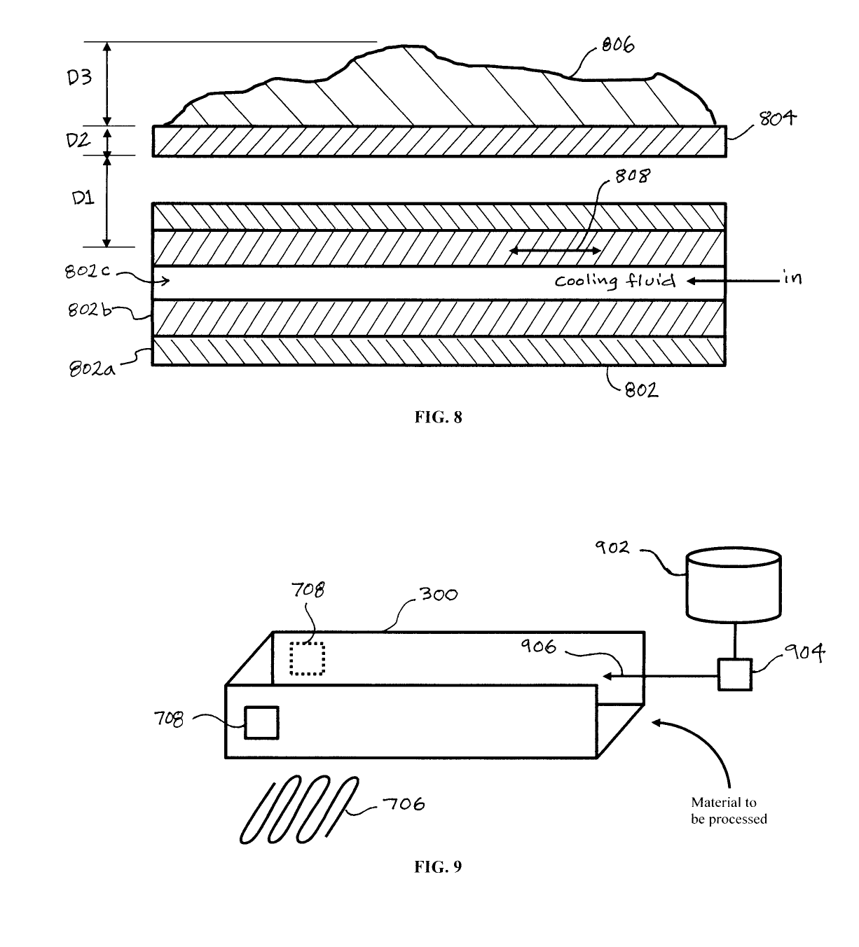

Turning next to FIG. 8, shown therein is a cross-sectional elevation view diagram of an induction heating element 802, a vessel 804, and a material to be processed 806, according to one aspect of the present invention. The induction heating element 802 includes an outer layer 802a, a conductor 802b, and an inner open space 802c.

The outer layer 802a may be composed of, for example, a ceramic material, which is design to protect the inner conductor 802b from damage. The conductor may be made of, for example, copper or some other electrically-conductive material. In operation, the direction a current 808 passing through the inner conductor 802b is changed from one direction to the other direction, and occurs at a pre-determined frequency, such as less than about 50 kHz to less than about 10 kHz (or at some other frequency).

The inner space 802c, which may be tubular, may contain a working fluid, such as water, to cool the conductor 802b during operation. The thermal energy received by the working fluid is then discharged to the atmosphere as discussed above.

The current induced in the vessel 804 and/or the material 806 due to the magnetic field created by the induction heating element 802 will be proportional to the current in the inner conductor 802b and to the inverse of the square of the distance between them (i.e., the distance D1, or D1+D2, which is the approximate distance between the inner conductor 802b and the inner and outer walls of the vessel 804, or the distance D1+D2+D3, which is the approximate distance between the inner conductor 802b and the farthest point in the material 806). The closer the induction heating element 802 is to the wall of the vessel 804 (i.e., the smaller the distance D1), the greater the effect the magnetic field will have on the vessel 804 and the material 806.

Turning next to FIG. 9, shown therein is a perspective view schematic and block diagram of one embodiment of the invention in which a liquid is flash evaporated according to the present invention. As depicted, a vessel 300 is placed on the ground over one or more induction heating elements 706. One or more sensors 708 are positioned along the walls of the vessel 300 to monitor the temperature of a material inside the vessel 300. Liquids stored in tank 902 are transferred by pump 904 through a manifold (not shown) to one or more spray nozzles 906 (depicted schematically as a single arrow). The liquid is thus sprayed over the portion of the bin heated by the induction heating elements 706, which causes the liquid to nearly instantaneously evaporate (flash) from liquid form to vapor/gas form.

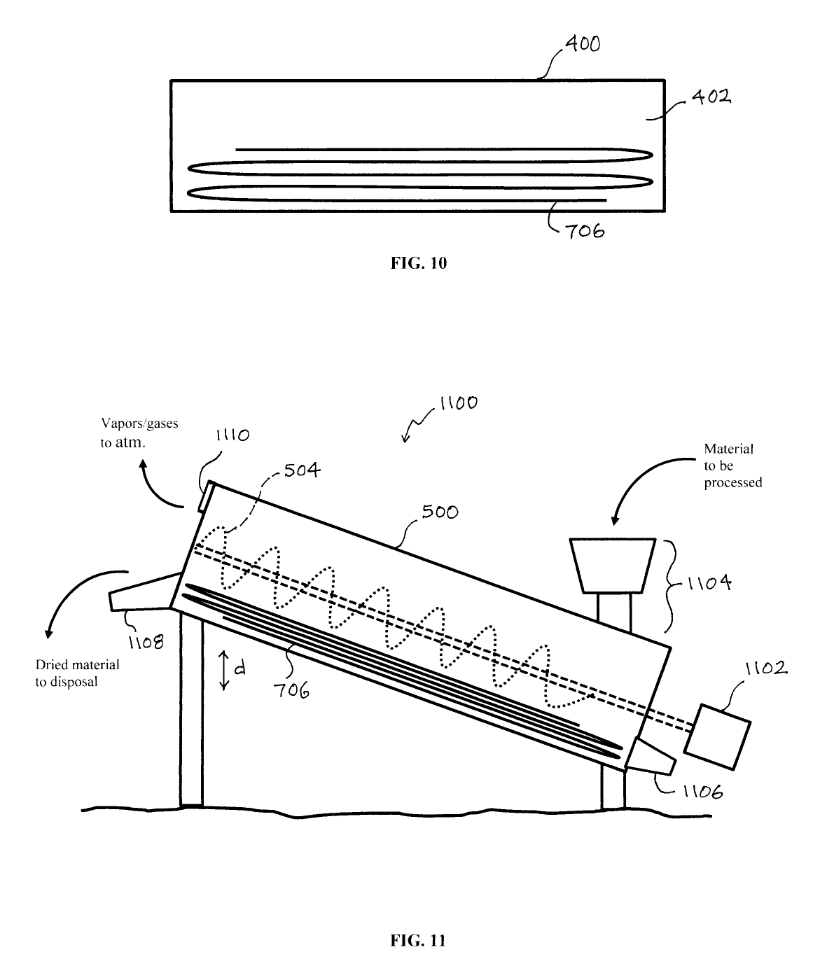

Turning next to FIG. 10, shown therein is a side elevation view diagram of a material processing vessel, such as the vessel 400 shown in FIG. 4, and an induction heating element 706 arranged on the lower portion and bottom of the side 402 of the vessel 400 according to one embodiment of the present invention. The induction heating element 706 is attached to the outer wall of the vessel 400.

Turning next to FIG. 11, shown therein is side elevation schematic view diagram of another material processing system 1100, which includes an inclined vessel 500, like the inclined vessel depicted in FIG. 5, and an induction heating element 706, according to one embodiment of the present invention. The system 1100 includes an auger 504, auger drive motor 1102, material inlet funnel 1104, free liquid outlet opening or nozzle 1106, discharge chute 1108, and vapor/gas outlet vent 1110.

The inclined vessel 500 is supported above the ground surface on legs, which may be in the form of, for example, hydraulic or ratcheted jacks or poles. The height each end of the inclined vessel 500 is raised above the ground surface may be adjusted on-site, such that the distance the discharge end is above the ground, d, may be varied.

The induction heating element 706 may a device like the induction heating element as previously described in connection with FIGS. 7-10. The auger 504 is powered by an auger drive motor 1102, which may include a belt or chain drive attached to a cam of an electrical or gas-fired motor. The material inlet funnel 1104 should be large enough to collect the material dropped from a front-end loader, bucket, or dump truck (in the case where a ramp allows the truck to back up to and above the material inlet funnel 1104). The free liquid outlet opening or nozzle 1106 allows the operator to collect liquids that have separated from the material and run down the inclined vessel 500 due to gravity. The discharge chute 1108 should be large enough to output the material being pushed along by the auger 504. The vent/gas outlet 1100 is used to discharge liquids that have evaporated inside the inclined vessel 500 and are in the vapor or gas phase. A fan or vacuum (not shown) may be used to facilitate removal of vapors/gases present inside the inclined vessel 500.

Various sensors 708 (not shown) may be positioned around and along the length of the inclined vessel 500 to monitor the rate at which liquid in the material is evaporating, which in turn may be used to adjust the speed of the auger (which affects the contact time of the material inside the inclined vessel 500), the current passing through the induction heating element 706, or both.

The location/position of the above components of the system 1100 are for illustrative purposes only, as one skilled in the art will appreciate that they may be located at different positions on the inclined vessel 500.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A magnetic induction heating system comprising:
at least one magnetic induction element for outputting a magnetic field corresponding to an electrical current passing through the at least one magnetic induction element, wherein the at least one magnetic induction element is adapted to being placed in proximity to or attached to a vessel;
a current delivery circuit for directing the electrical current through the at least one magnetic induction element;
at least one sensor for outputting a signal corresponding to a property of the portion of the vessel that is exposed to the magnetic field, or corresponding to a property of a material placed inside the vessel that is exposed to the magnetic field; and
a controller for receiving the signal from the at least one sensor and outputting a signal to the current delivery circuit to change the electric current being directed to the at least one magnetic induction element.

2. The system of claim 1, wherein the vessel is an elongated rectangular three-sided open bin comprising three walls and a floor, and wherein the at least one magnetic induction element is placed below the floor of the vessel when the vessel is place on a surface.

3. The system of claim 1, wherein the vessel is an elongated half-pipe trough, and wherein the at least one magnetic induction element is placed in contact with an outer wall portion of the trough.

4. The system of claim 1, wherein the vessel is an inclined elongated rectangular four-sided closed bin comprising three side walls, a floor wall, and two end walls, and wherein the at least one magnetic induction element is placed in contact with an outer wall portion of the vessel.

5. The system of claim 4, further comprising an auger inside the vessel aligned substantially coaxially with the longitudinal axis of the vessel.

6. The system of claim 1, wherein the at least one magnetic induction element comprises:
an outer substantially tube-shaped layer; and
an inner substantially tube-shaped electrical conducting layer substantially coaxially aligned with the outer layer,
wherein the inner layer forms a circular space adapted to transporting a cooling fluid from one end of the at least one magnetic induction element to the other end of the at least one magnetic induction element.

7. The system of claim 1, further comprising a cooling system for cooling the at least one magnetic induction element.

8. The system of claim 1, further comprising a flash evaporator subsystem comprising:
at least one adjustable nozzle for directing a portion of a liquid toward a portion of the vessel for heating the liquid;
a manifold for distributing the liquid to the at least one nozzle; and
a pump for transporting the liquid to the manifold and then the nozzle.

9. A method for using a magnetic induction heating system comprising:
positioning at least one magnetic induction element near or on a vessel, wherein the at least one magnetic induction element is adapted to outputting a magnetic field corresponding to an electrical current passing through the at least one magnetic induction element;
positioning at least one sensor near or on the vessel, wherein the at least one sensor is adapted to outputting a signal corresponding to a property of a portion of the vessel exposed to the magnetic field, or corresponding to a property of a material contained within the vessel exposed to the magnetic field, and wherein the signal corresponds to at least a temperature;
inputting into an input device of a controller a value for each one of one or more parameters, including at least a time and a temperature parameter;
receiving in the controller the signal from the at least one sensor;
comparing at the controller the received signal to the inputted values for the one or more parameters, and outputting to a current delivery circuit a signal instructing the current delivery circuit to either adjust or not adjust the electrical current; and
outputting from the current delivery circuit the electrical current to the at least one magnetic induction element based on the instruction signal.

10. The method according to claim 7, further comprising:
identifying the material;
identifying the value for each one of the one or more parameters based on the identified material;
placing the material inside the vessel; and
removing the material from the vessel after a pre-determined condition is met.

11. The method according to claim 10, wherein the pre-determined condition is one of an amount of elapsed time, an amount of liquid evaporated from the material, an amount of liquid by weight or volume in the material, and amount of weight of material, and amount of change in temperature of the material or the vessel, and a time of day.

12. A magnetic induction heating system comprising:
an inclined elongated rectangular vessel comprising:
two spaced apart substantially parallel sides, a top, a floor spaced apart from and substantially parallel to the floor, and two spaced apart ends, wherein the sides, top, floor, and ends substantially enclose a space;
an auger inside the space and aligned substantially coaxially with the longitudinal axis of the vessel for continuously transporting a material entering the vessel at one of the two ends;
an adjustable speed drive motor connected to the auger for causing the auger to rotate;
a discharge chute for discharging the material exiting the vessel at the other one of the two ends; and
a vent for discharging a vapor or gas generated inside the vessel;
a magnetic induction element for outputting a magnetic field corresponding to an electrical current passing through the magnetic induction element, wherein the magnetic induction element is attached to the outside of the two sides of the vessel substantially opposite each other;
a current delivery circuit connected to an electrical power source for directing the electrical current through the magnetic induction element;
a plurality of thermocouple sensors spaced apart along the two sides, top, or floor of the vessel for outputting a signal corresponding to a temperature of a portion of the vessel exposed to the magnetic field, or corresponding to a temperature of the material contained within the vessel exposed to the magnetic field; and
a controller for receiving the signals from the plurality of thermocouple sensors and outputting a signal to the current delivery circuit to change the electric current being directed to the magnetic induction element.

13. The magnetic induction heating system of claim 12, wherein the auger is adapted to transporting a drilling mud containing a mixture of solids and liquids.

14. The magnetic induction heating system of claim 12, wherein the magnetic induction element comprises a ceramic outer layer.

15. The magnetic induction heating system of claim 12, further comprising a cooling system for cooling the magnetic induction element.

16. The magnetic induction heating system of claim 15, wherein the cooling system provides a cooling fluid for transferring heat from the magnetic induction element to the atmosphere.
